(19) United States
(12) Patent Application Publication
(10) Pub. No.: US 2022/0150110 A1
(43) Pub. Date: May 12, 2022

(54) EDGE SERVER SYSTEM MANAGEMENT AND CONTROL METHOD IN RUGGED ENVIRONMENT

(71) Applicant: Korea Electronics Technology Institute, Seongnam-si (KR)

(72) Inventors: Jae Hoon AN, Incheon (KR); Young Hwan KIM, Yongin-si (KR)

(73) Assignee: Korea Electronics Technology Institute, Seongnam-si (KR)

(21) Appl. No.: 17/497,098

(22) Filed: Oct. 8, 2021

(30) Foreign Application Priority Data
Nov. 6, 2020 (KR) 10-2020-0147247

(51) Int. Cl. H04L 12/24; H04L 29/08

(52) U.S. Cl. CPC H04L 41/0803; H04L 67/10

(57) ABSTRACT

There is provided an edge server system management and control method in a rugged environment. An edge server management apparatus according to an embodiment of the present disclosure includes: a communication unit configured to communicate with an edge server; and a processor configured to collect environmental information of the edge server through the communication unit, and to control an external environment of the edge server and to control resource configuration for an edge service, based on the collected environmental information. Accordingly, it is possible to manage/control an edge server system-based configuration module (a fan, a heater) even, and to operate an edge service by reconfiguring resources of the edge server in a severe industrial site.

### CROSS-REFERENCE TO RELATED APPLICATION(S) AND CLAIM OF PRIORITY

This application is based on and claims priority under 35 U.S.C. § 119 to Korean Patent Application No. 10-2020-0147247, filed on Nov. 6, 2020, in the Korean Intellectual Property Office, the disclosure of which is herein incorporated by reference in its entirety.

### BACKGROUND

### Field

The present disclosure relates generally to edge server management and control technology, and more particularly, to a method for effectively managing and controlling an environment and a resource configuration of an edge server system in a rugged environment.

### Description of Related Art

In a rugged environment (severe environment), IT equipment is difficult to operate normally, and management and control therefor is more essential. Current technology for overcoming the rugged environment only focuses on hardware-level approach for reinforcing/supplementing an exterior of IT equipment.

However, abnormal climate conditions which are becoming serious recently make it more difficult to respond with only the above-described approach. Accordingly, there is a need for a method for responding to a rugged environment from a different viewpoint.

In addition, management and control of equipment by the above-described technology should be implemented for generic purposes and should interlock with industrial standards.

### SUMMARY

To address the above-discussed deficiencies of the prior art, it is a primary object of the present disclosure to provide an edge server management and control method in a rugged environment, as a solution for enabling an edge service to operate in a severe industrial site and for expanding/reconfiguring resources variably according to a service condition and a demand for resources.

In addition, another object of the present disclosure is to provide a structure which can apply a module for managing/controlling an edge server in a rugged environment to an edge server system based on Redfish standards.

According to an embodiment of the present disclosure to achieve the above-described object, an edge server management apparatus includes: a communication unit configured to communicate with an edge server; and a processor configured to collect environmental information of the edge server through the communication unit, and to control a function of the edge server, based on the collected environmental information.

The processor may expand or reconfigure resources of the edge server by collecting state information of the edge server.

In addition, the edge server may be a server that provides an edge service in a rugged environment.

The processor may control an environment of the edge server by operating a fan and a heater when the environment is in a first state.

The processor may reconfigure resources for the edge service when the environment is in a second state.

The environment may include temperature, humidity, and dusts.

The temperature may be temperature inside a chassis.

The processor may interrupt the edge service when an external environment is in a third state.

The processor may request the interrupted edge service to be transferred to another system.

According to another embodiment of the present disclosure, an edge server management method may include: collecting environmental information of an edge server; and controlling an external environment of the edge server and resource configuration for an edge service, based on the collected environmental information.

According to still another embodiment of the present disclosure, an edge server management apparatus includes: a communication unit configured to communicate with an edge server which provides an edge service in a rugged environment; and a processor configured to collect state information of the edge server through the communication unit, and to reconfigure resources of the edge server, based on the collected state information.

According to yet another embodiment of the present disclosure, an edge server management method includes: collecting state information of an edge server which provides an edge service in a rugged environment; and reconfiguring resources of the edge server, based on the collected state information.

According to embodiments of the present disclosure as described above, it is possible to manage/control an edge server system-based configuration module (a fan, a heater) even in a severe industrial site, and to operate an edge service by reconfiguring resources of the edge server.

In addition, according to embodiments of the present disclosure, a module for managing/controlling an edge server in a rugged environment can be applied to an edge server system based on Redfish standards, so that management and control of the edge server can be implemented for generic purpose and can interlock with industrial standards.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating an edge server system to which the present disclosure is applicable;

FIGS. 2 and 3 are views illustrating a list of control/management functions that are performed by an edge management/control module with respect to an edge server system;

FIG. 4 is a view illustrating a concept of expansion/reconfiguration of resources of an edge server by an edge management/control module in a rugged environment;

FIG. 5 is a flowchart provided to explain an edge server system management/control method in a rugged environment according to an embodiment of the present disclosure; and

FIG. 6 is a detailed block diagram of the edge management/control module illustrated in FIG. 1.

### DETAILED DESCRIPTION

Hereinafter, the present disclosure will be described in detail with reference to the accompanying drawings.

In an embodiment of the present disclosure, a method and a module for managing/controlling an edge server in a rugged environment are suggested.

Specifically, in an embodiment of the present disclosure, there is provided a method for controlling not only an environment of an edge server but also a resource configuration of the edge server in order for the edge server to normally provide an edge service even in a rugged environment.

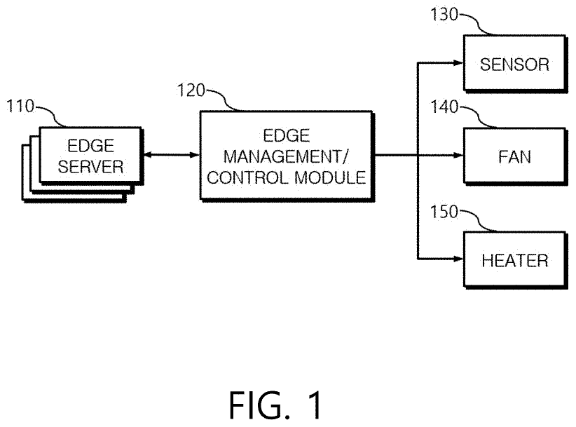

FIG. 1 is a view illustrating an edge server system to which the present disclosure is applicable. The edge server system to which the present disclosure is applicable includes an edge server 110, an edge management/control module 120, a sensor 130, a fan 140, and a heater 150.

The edge server 110 is a server that performs edge computing to provide an edge service. Since the edge server 110 is generated for every edge service, a plurality of edge servers may be generated.

The edge management/control module 120 is installed in the edge server system to manage and control the edge server 110. When necessary, the edge management/control module 120 may be positioned outside the edge server system.

A Redfish interface (IF) may be applied as an interface for connecting/managing/controlling the edge management/control module 120 and the edge server 110.

The sensor 130 is configured to collect environmental information (temperature, humidity, dusts, etc.) of the edge server system, and the fan 140 and the heater 150 are configured to control temperature of the edge server system.

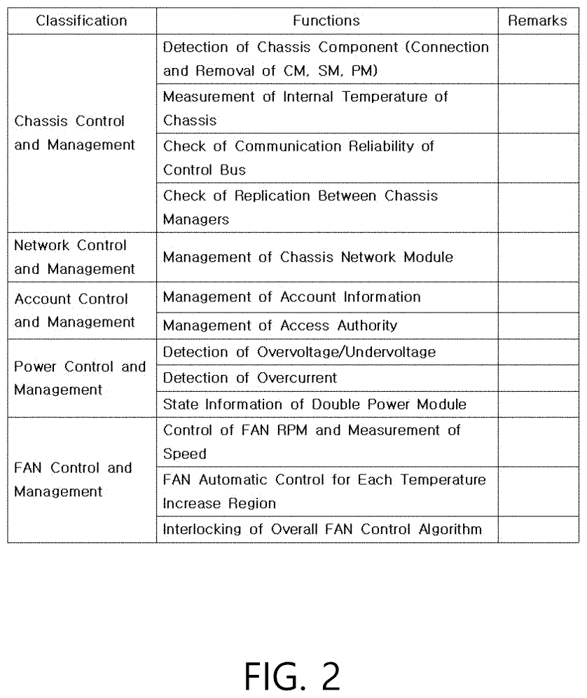

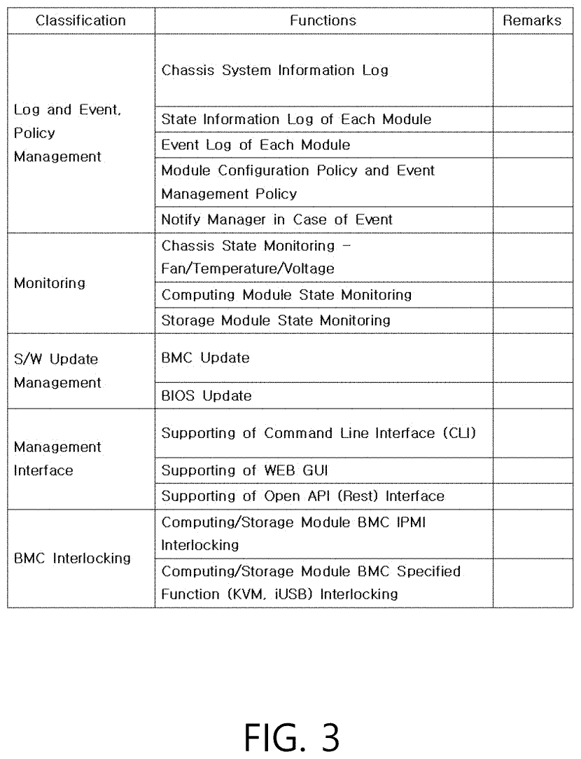

Control/management functions that are performed by the edge management/control module 120 with respect to the edge server system are listed in FIGS. 2 and 3.

As shown in FIG. 2, the edge management/control module 120 provides a chassis control/management function, a network control/management function, an account control/management function, a power control/management function, and a fan control/management function of the edge server system.

To provide a smooth edge service in a rugged environment, the chassis control/management function includes a chassis internal temperature measurement function, and the fan control/management function includes a fan automatic adjustment function for each temperature increase region and an overall fan control function.

As shown in FIG. 3, the edge management/control module 120 provides a log, event, and policy management function, a chassis, fan, resource state monitoring function, a software (BMC, BIOS) update management function, a management interface support function, a BMC interlocking function of the edge server system.

To provide a smooth edge service in a rugged environment, the monitoring function includes a chassis state (fan/temperature/voltage) monitoring function.

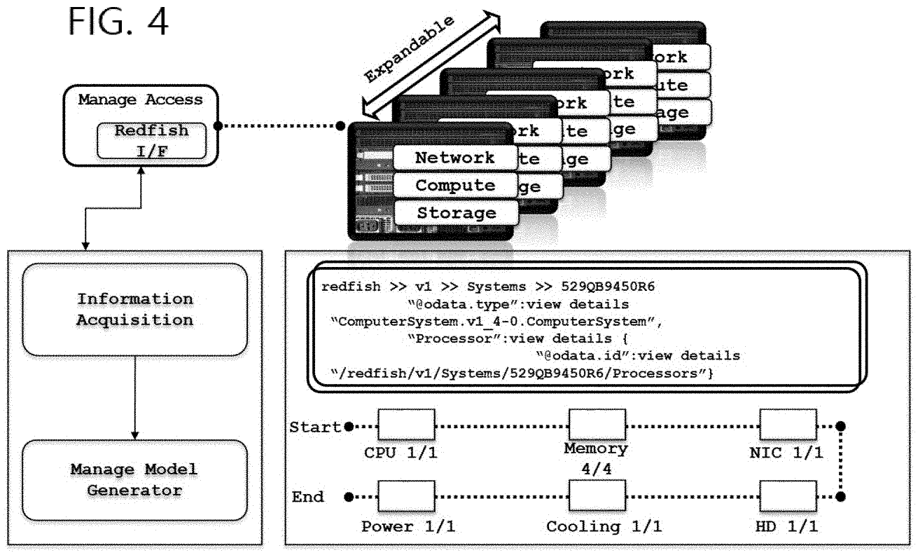

FIG. 4 illustrates a concept of a function of performing resource expansion/reconfiguration of the edge server by the edge management/control module 120 in a rugged environment.

As shown in FIG. 4, the edge management/control module 120 may generate a management/control model by collecting request information of a user about the edge service and state information of the edge server, and may expand or reconfigure resources of the edge server according to the generated management/control model.

The edge management/control module 120 manages and controls the edge server system to respond to the rugged environment, by referring to environmental information of the edge server system which is collected through the sensor 130.

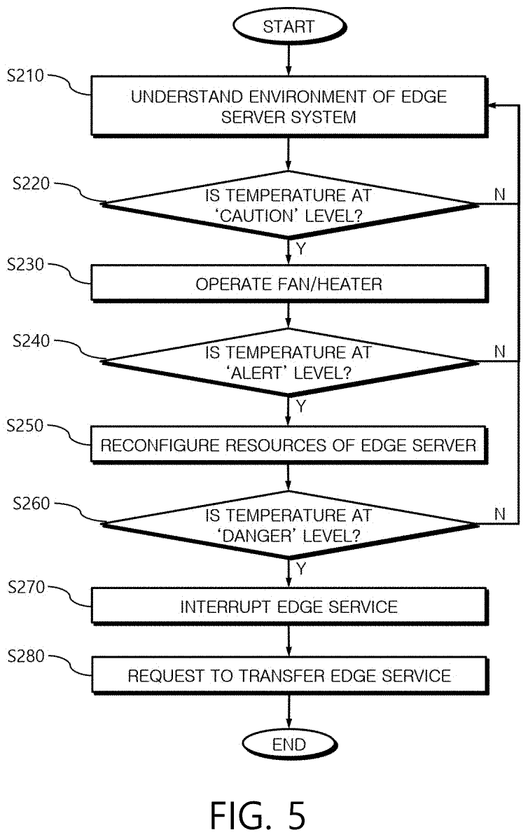

Hereinafter, a detailed process of controlling, by the edge management/control module 120, the edge server system in a rugged environment will be described in detail with reference to FIG. 5. FIG. 5 is a flowchart provided to explain an edge server system management/control method in a rugged environment according to an embodiment of the present disclosure.

As shown in FIG. 5, the edge management/control module 120 understands an environment of the edge server system by collecting environmental information from the sensor 130, first (S210). The collected environmental information includes information on temperature, humidity, dusts, etc.

When temperature is determined as a ‘caution’ level at step S210 (S220-Y), the edge management/control module 120 controls the environment of the edge server 110 by operating the fan 140 and the heater 150 (S230).

A temperature range of the ‘caution’ level may be set to an appropriate range according to necessity, for example, to 40 to 50° C. and −10 to 0° C.

Specifically, at step S230, the fan 140 is operated in a high-temperature environment, and the heater 150 is operated in a low-temperature environment.

When temperature is raised to an ‘alert’ level (S240-Y), the edge management/control module 120 reconfigures resources of the edge server 110 for the edge service, and controls the environment of the edge server 110 (S250).

A temperature range of the ‘alert’ level may be set to an appropriate range according to necessity, for example, to 50 to 60° C. and −20 to −10° C.

Specifically, at step S250, allocated resources are reduced in a high-temperature environment, and allocated resources increase in a low-temperature environment. This considers that heat emission from the edge server 110 increases as more resources are allocated.

When temperature is further raised to a ‘danger’ level nevertheless (S260-Y), the edge management/control module 120 interrupts the edge service by shutting off power to the edge server 110 (S270).

A temperature range of the ‘danger’ level may be set to an appropriate range according to necessity, for example, to higher than 60° C. and less than −20° C.

Step S270 is to perform a function for protecting the edge server 110 from the rugged environment. When humidity or dusts are at the danger level, in addition to temperature, the edge service may be interrupted by shutting off power to the edge server 110.

When the edge service is interrupted at step S270, the edge management/control module 120 may request the interrupted edge service to be transferred to another system (S280).

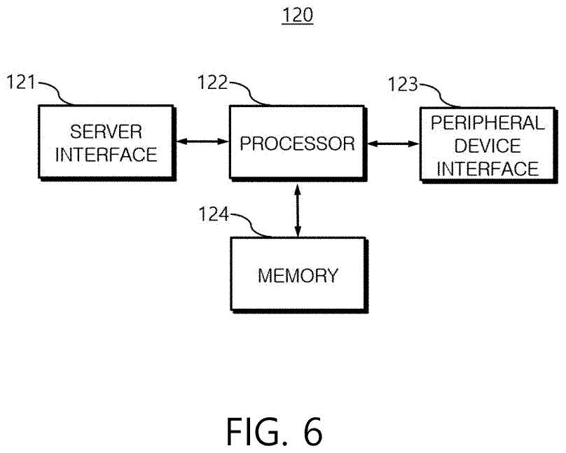

Hereinafter, a detailed configuration of the edge management/control module 120 shown in FIG. 1 will be described in detail with reference to FIG. 6. FIG. 6 is a detailed block diagram of the edge management/control module 120.

As shown in FIG. 6, the edge management/control module 120 includes a server interface 121, a processor 122, a peripheral device interface 122, and a memory 124.

The server interface 121 is an interface for communication connection and data communication with the edge server 110, and the peripheral device interface 124 is an interface for communication connection and data communication with the sensor 130, the fan 140, and the heater 150.

The processor 122 performs functions necessary for managing/controlling the edge server system, suggested in FIGS. 2, 3, 4, and 5. The memory 123 provides a storage space necessary for the processor 122 to perform corresponding functions.

Up to now, the edge server management and control method in the rugged environment has been described in detail with reference to preferred embodiments.

The above-described embodiments suggest a method of applying a management module for supporting a system structure (architecture) capable of operating an edge service and expanding/reconfiguring computing and storage capacity variably according to a service condition and a resource request.

In addition, a technique for supporting a remote control/management structure of a Redfish standards-based edge server system to apply a management module based on a rugged environment is suggested.

Accordingly, it is possible to provide a function of managing/controlling an edge server system-based configuration module (power, FAN, temperature, sensor), and an expandable control function, to provide a function of controlling operation temperature for providing a continuous service in a severe industrial site (temperature, humidity, dust, etc.) and a function of controlling variable expansion/reconfiguration of computing/storage resource capacity, and to provide a generic-purpose management interface based on industrial standards, Redfish.

The technical concept of the present disclosure may be applied to a computer-readable recording medium which records a computer program for performing the functions of the apparatus and the method according to the present embodiments. In addition, the technical idea according to various embodiments of the present disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the art without departing from the scope of the present disclosure claimed in claims, and also, changed embodiments should not be understood as being separate from the technical idea or prospect of the present disclosure.

What is claimed is:

1. An edge server management apparatus comprising:
a communication unit configured to communicate with an edge server; and
a processor configured to collect environmental information of the edge server through the communication unit, and to control a function of the edge server, based on the collected environmental information.

2. The edge server management apparatus of claim 1, wherein the processor is configured to expand or reconfigure resources of the edge server by collecting state information of the edge server.

3. The edge server management apparatus of claim 1, wherein the edge server is a server that provides an edge service in a rugged environment.

4. The edge server management apparatus of claim 1, wherein the processor is configured to control an environment of the edge server by operating a fan and a heater when the environment is in a first state.

5. The edge server management apparatus of claim 4, wherein the processor is configured to reconfigure resources for the edge service when the environment is in a second state.

6. The edge server management apparatus of claim 5, wherein the environment comprises temperature, humidity, and dusts.

7. The edge server management apparatus of claim 6, wherein the temperature is temperature inside a chassis.

8. The edge server management apparatus of claim 4, wherein the processor is configured to interrupt the edge service when an external environment is in a third state.

9. The edge server management apparatus of claim 8, wherein the processor is configured to request the interrupted edge service to be transferred to another system.

10. An edge server management method comprising:
collecting environmental information of an edge server; and
controlling an external environment of the edge server and resource configuration for an edge service, based on the collected environmental information.

11. An edge server management apparatus comprising:
a communication unit configured to communicate with an edge server which provides an edge service in a rugged environment; and
a processor configured to collect state information of the edge server through the communication unit, and to reconfigure resources of the edge server, based on the collected state information.
